(19) United States
(12) Patent Application Publication
(10) Pub. No.: US 2009/0006388 A1
(43) Pub. Date: Jan. 1, 2009

(54) SEARCH RESULT RANKING

(75) Inventors: Stephen Ives, Swavesey (GB); Stefan Butlin, Cambridge (GB)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/147,646

(22) Filed: Jun. 27, 2008

Related U.S. Application Data
(60) Provisional application No. 60/946,728, filed on Jun. 28, 2007.
(60) Provisional application No. 60/946,730, filed on Jun. 28, 2007.

(51) Int. Cl. G06F 17/30

(52) U.S. Cl. 707/5; 707/E17.014

(57) ABSTRACT

A search engine (50, 35, 45,103) can find content items in a first corpus (6, 30), and return search results to the user as items ranked according to mentions in a second corpus (7, 77, 87, 30), of the respective found content items. This introduces a degree of independence or separation between the scope and type of the information for ranking and the scope and type of the content items used for responding to the search query. The second corpus can be limited to human moderated discussion sites, to provide a more reliable measure of how topical is the item. The first corpus can be limited to mobile web pages. The ranking can also involve a count of mentions in plain text referring to the respective found content items, or be according to a social distance between the user and another user, to whom the respective content item is related.

### RELATED APPLICATIONS

This application claims the benefit of earlier filed provisional applications having Ser. No. 60/946,728 filed 28 Jun. 2007 entitled “Ranking Search Results Using a Measure of Buzz, and Ser. No. 60/946,730 filed 28 Jun. 2007 entitled “Social distance search ranking”.

This application also relates to five earlier US patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 6 Mar. 2006, published as US2007/0208704 entitled “Packaged mobile search results”. This application also relates to provisional applications:

Ser. No. 60/946,729 filed 28 Jun. 2007 entitled “Method of Enhancing Availability of Mobile Search Results”,

Ser. No. 60/946,726 filed 28 Jun. 2007 entitled “Audio Thumbnail”,

Ser. No. 60/946,727 filed 28 Jun. 2007 entitled “Managing Mobile Search Results”,

Ser. No. 60/946,731 filed 28 Jun. 2007 entitled “Festive Mobile Search Results”. The contents of these applications are hereby incorporated by reference in their entirety.

### FIELD OF THE INVENTION

This invention relates to search engines, to corresponding methods of providing a search service, to methods of using such search engine services, and to corresponding programs or components of the above.

### DESCRIPTION OF THE RELATED ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance. The documents are ranked by various measures referred to as relevance, usefulness, or value measures. A metasearch engine accepts a search query, sends the query (possibly transformed) to one or more regular search engines, and collects and processes the responses from the regular search engines in order to present a list of documents to the user.

It is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank™ is a static ranking of web pages used as the core of the search engine known by the trademark Google (http://www.google.com).

As is acknowledged in U.S. Pat. No. 6,751,612 (Schuetze), because of the vast amount of distributed information currently being added daily to the Web, maintaining an up-to-date index of information in a search engine is extremely difficult. Sometimes the most recent information is the most valuable, but is often not indexed in the search engine. Also, search engines do not typically use a user's personal search information in updating the search engine index. Schuetze proposes selectively searching the Web for relevant current information based on user personal search information (or filtering profiles) so that relevant information that has been added recently will more likely be discovered. A user provides personal search information such as a query and how often a search is performed to a filtering program. The filtering program invokes a Web crawler to search selected or ranked servers on the Web based on a user selected search strategy or ranking selection. The filtering program directs the Web crawler to search a predetermined number of ranked servers based on: (1) the likelihood that the server has relevant content in comparison to the user query (“content ranking selection”); (2) the likelihood that the server has content which is altered often (“frequency ranking selection”); or (3) a combination of these.

According to US patent application 2004044962 (Green), current search engine systems fail to return current content for two reasons. The first problem is the slow scan rate at which search engines currently look for new and changed information on a network. The best conventional crawlers visit most web pages only about once a month. To reach high network scan rates on the order of a day costs too much for the bandwidth flowing to a small number of locations on the network. The second problem is that current search engines do not incorporate new content into their “rankings” very well. Because new content inherently does not have many links to it, it will not be ranked very high under Google's PageRank™ scheme or similar schemes. Green proposes deploying a metacomputer to gather information freshly available on the network; the metacomputer comprises information-gathering crawlers instructed to filter old or unchanged information. To rate the importance or relevance of this fresh information, the page having new content is partially ranked on the authoritativeness of its neighboring pages. As time passes since the new information was found, its ranking is reduced.

### SUMMARY

An object of the invention is to provide improved apparatus or methods. Features of some embodiments of the invention can include:

A search engine for providing a search service for searching content items accessible online, the search engine having a query server arranged to receive a search query from a user, find content items relevant to the search query in a first corpus, and return search results to the user indicating at least some of the found content items ranked according to mentions in a second corpus, of the respective found content items.

Using mentions in a second corpus for the ranking, introduces a degree of independence or separation between the scope and type of the information for ranking and the scope and type of the content items used for responding to the search query. This enables these two corpuses to be tailored or optimized separately to suit their own needs. Some other embodiments of the invention can include:

A search engine for providing a search service for searching content items accessible online, the search engine having a query server arranged to receive a search query from a mobile device of a user, and return search results to the user, the search engine being arranged to find content items relevant to the search query, and derive the search results by ranking at least some of the found content items according to at least a count of mentions in plain text referring to the respective found content items.

Such plain text mentions can in some cases provide better ranking than relying on backlinks to a webpage containing the content item for example. Some other embodiments of the invention can include:

A search engine for providing a search service for searching content items accessible online, the search engine having a query server arranged to receive a search query from a mobile device of a user, find content items relevant to the search query, and rank at least some of the found content items according to a social distance between the user and another user, to whom the respective content item is related.

This can help enable improved ranking based on the likelihood that a level of interest in the content items is related to how close is the other user.

Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIGS. 1 to 3 show a topology of a search engine according to various embodiments,

FIGS. 4 to 6 shows actions of parts of embodiments using mentions for ranking,

FIG. 7 shows, an overall topology of an embodiment,

FIG. 8 shows a flow chart of actions of some parts of the embodiment of FIG. 7,

FIG. 9, shows an overall topology for an embodiment having customised mention counting,

FIG. 10 shows a flow chart of actions of some parts of the embodiment of FIG. 9,

FIG. 11 shows an overall topology for an embodiment having mention counting using a same search engine

FIG. 12 shows a flow chart of actions of some parts of the embodiment of FIG. 11,

FIG. 13 shows a flow chart of actions of some parts of the embodiment involving on line mention counting,

FIG. 14 shows an overall topology for an embodiment having ranking by social distance,

FIG. 15 shows a flow chart of actions of some parts of the embodiment of FIG. 14,

FIG. 16 shows a flow chart of actions of an embodiment of a query server,

FIG. 17 shows a flow chart of actions of an embodiment of an index server, and

FIG. 18 shows indexes for different web collections according to another embodiment.

### DESCRIPTION OF THE PREFERRED EMBODIMENTS

### Definitions

A corpus is intended to encompass any collection of content items accessible for searching by a computer of a user, or accessible online, such as all or any part of the world wide web, any collection of web pages, any web site or collection of web sites, any database, any collection of data files, audio, image or video files and so on. It can be located anywhere, such as in storage controlled by web servers, in online databases, in a web mirror crawled from the web, in an indexed web collection, in storage associated with an intranet, or local storage in the user's own computing device and so on.

Score can be any kind of score and encompasses for example a count, a weighted count, an average over time, and so on.

Online means accessible by computer over a network and so can encompass accessible via the internet or public telecommunications networks, or via private networks such as corporate intranets.

Mentions of content items can encompass for example any reference such as all mentions in any form including mentions of URLs, hyperlinks, abbreviations, titles, acronyms, synonyms, thumbnail images, summaries, reviews, extracts, samples, translations, and derivatives colloquial names, identifiers such as product numbers, ISBN numbers for books and so on, or any string of characters that identifies the content, by name or indirectly by location or by its characteristics for example. Mentions can encompass plain text strings or non plain text such as control characters for example hypertext.

Content items encompasses web pages, or extracts of web pages, or programs or files such as images, video files, audio files, text files, or parts of or combinations of any of these and so on.

User can encompass human users or services such as meta search services.

Items which are “accessible online” are defined to encompass at least items in pages on websites of the world wide web, items in the deep web (e.g. databases of items accessible by queries through a web page), items available internal company intranets, or any online database including online vendors and marketplaces.

Changes in occurrence can mean changes in numbers of occurrences and/or changes in quality or character of the occurrences such as a move of location to a more popular or active site.

Hyperlinks are intended to encompass hypertext, buttons, softkeys or menus or navigation bars or any displayed indication or audible prompt which can be selected by a user to present different content.

The term “comprising” is used as an open ended term, not to exclude further items as well as those listed.

### Introduction to Embodiments

Search engines exist for discovering (searching for) desktop web pages and mobile web pages. A mobile web page is defined as a website whose content is rendered using HTML that can be reasonably viewed and navigated within the constrained display and network capabilities of a mobile device or handset. Mobile search engines prompt the user for a search term (or terms) and the user hopes to find links to the most relevant mobile web pages. The common technique in desktop search engines of using the link structure between pages to help rank popular (more linked) pages higher than unpopular (less linked) pages does not map well to mobile web pages for two reasons: firstly mobile pages are much fewer in number and secondly mobile pages contain far fewer links to other mobile pages. This means the link-weighting technique is less effective for ranking mobile web pages.

Most search engine algorithms begin by performing a word match across all candidate documents (web pages) and then proceed to sort and filter these matching pages with many algorithms including the link-weighting mentioned above. However, for mobile pages, even the word matching algorithms are less effective as the quantity of text available for indexing is smaller. Thus the statistical significance of a word match in one document compared to another is hard to differentiate.

While the above techniques can be used in their limited capacity, embodiments of the present invention add another factor into the sorting algorithm to improve the probability of placing a more relevant (or at least more interesting) mobile web page higher up the result list.

In the embodiments described below, the further factor for the ranking can be based on:

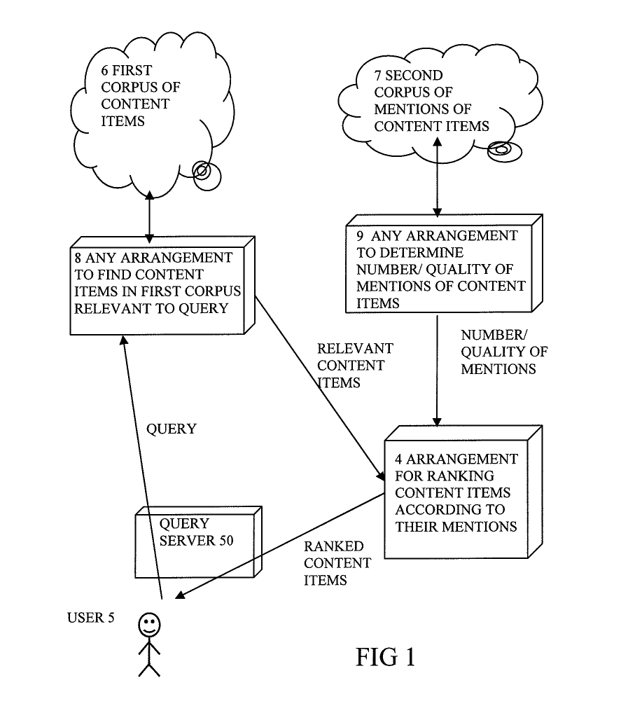

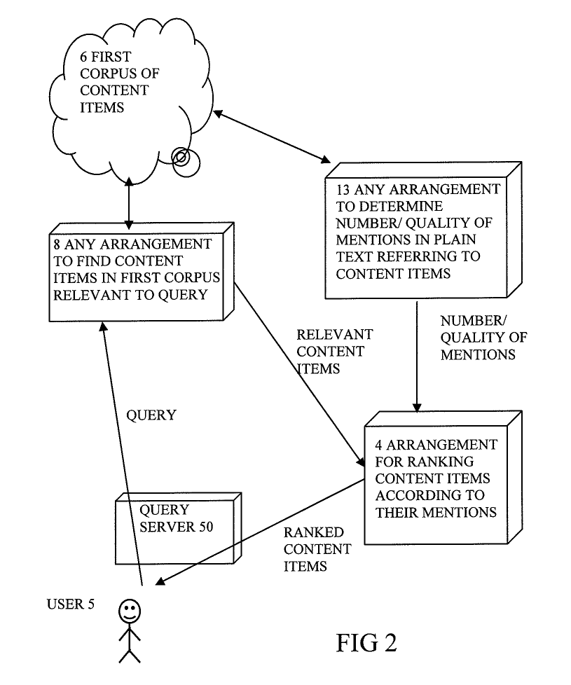

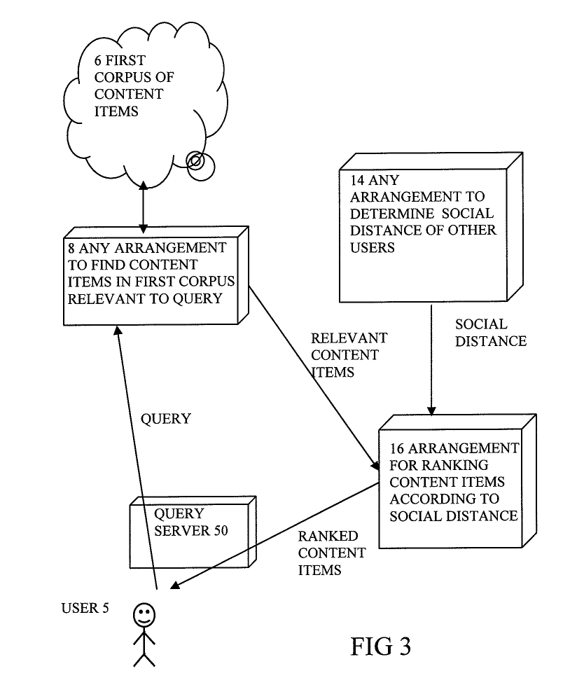

a) mentions in a second corpus, such as those which can indicate a degree of buzz, (see at least FIGS. 1, and 4-13 described below) or
b) mentions which are plain text whether in the same or a different corpus, (see at least FIGS. 2, and 4-13 described below and
c) for content items related to other users, a social distance to the other user in a social network (see FIGS. 3, 14 and 15 described below).

Any additional features can be added to these embodiments, some notable additional features are as follows:

The second corpus can comprise the worldwide web in some embodiments. Or, the second corpus can be limited to, or comprise predominantly human moderated discussion sites in other embodiments. Discussion sites can include any sites where users can contribute, including discussion groups, and other types. The first corpus can be limited to mobile web pages in some embodiments. The counts of mentions can include counts of a selected subset of mentions, to encompass selected types of mentions beyond simply all the backlinks.

Other embodiments of the search engine can be arranged to select from a number of indexed web collections for use as the first corpus, each of the indexed web collections being limited to a category of content items. The categories can be different subject matter categories or different types of media for example.

Users of such search services can derive benefits by carrying out the steps of sending a search query from a user to a search service provider, and receiving, from the search service provider, search results in the form of content items relevant to the search query in a first corpus, ranked according to mentions in a second corpus, of the respective found content items. This can involve the user using a mobile device to send the query and receive the search results. In some embodiments the user can send to the search service provider an indication of which of a number of indexed web collections to use as the first corpus, each of the indexed web collections being limited to a category of content items.

The corpuses will typically not be static, and their content will typically change over time. In some cases, it will be useful to have up to date or real time determination of mentions counts, either by updating an index of the second corpus sufficiently regularly, or in real time in response to a search query.

For embodiments using social distance for ranking, an additional feature is crawling a social network site for content items of many other users, recording which other user provided each content item, and recording social distance information for each other user. Another such additional feature of some embodiments is including content items from other users in the search results depending on viewing permissions granted by those other users to the user.

### Ranking Using Mentions in a Second Corpus to Measure Buzz

Some embodiments provide means to measure the degree of buzz associated mobile web sites and to therefore rank sites with lots of buzz higher than sites with less buzz. The degree of buzz associated with a given content item can be inferred from the buzz of the website or mobile website hosting the content item, or the buzz of the content item can be determined directly, to enable ranking of content items. Within the scope of such embodiments, buzz is defined as the number of mentions a content item such as a mobile web site is getting on a second corpus, such as the web in general or more specifically, on forums, blogs and other human-contributed content sites. The more a mobile site is talked about, the more likely it is that the intention of a user searching for it will be looking for it. Similarly, but not as strongly, the more a mobile site is talked about, the more likely it is that a user is interested in pages contained within that site. The use of mentions in a second corpus for the ranking, introduces a further degree of independence or separation between the scope and type of the information for ranking and the scope and type of the content items used for responding to the search query. This separation enables these two corpuses to be tailored or optimized separately to suit their own needs. For example, if there is insufficient information in the found content items, or in the first corpus, for ranking then the use of a second corpus which is broader than or at least different to the first corpus, can help improve the ranking. Alternatively, if there is too much information in the found content items or in the first corpus, it can be hard to find the right information for good ranking. In this case a narrower or different second corpus can help find the right information to enable improved ranking. Furthermore, having separate corpuses helps enable the scope of the first corpus to be selected, narrowed or broadened, to enable the finding of the content items to be improved with less or no impact on the ranking. This is particularly useful where the content items being sought are specialized and found in localized places away from information relevant to their ranking. The corpuses can be overlapping or not, either one can be a subset of the other, they can encompass any type of data including for example databases, media files, websites, subsets of the world wide web, and can be limited or broadened in any way, for example by file type, media type, (for example video, text, sound and so on), geographically, by time stamp, by content category (e.g. sport, movies, music and so on), or by restricting to sites or discussions known to be highly regarded or influential.

The use of separate corpuses can enable tailoring the ranking for particular purposes, for example for content items whose subjective value to the user depends on them being topical or fashionable. The corpus used for determining mentions can thereby encompass things like discussions and news items even if these are not suitable for including in the search domain for the content items (if for example the user is searching for images or mobile content). Thus the separation of corpuses for search and for ranking can help enable the ranking to be more relevant or carried out more efficiently. The search engine can identify sooner and more efficiently which content items are being discussed and thus by implication are more popular or more interesting.

Also, it can downgrade those which may be widely disseminated but less discussed for example. Thus the search results can be made more relevant to the user.

Using mentions of the content items found, can encompass more than the known limitation of counts only of backlinks to the page containing the content item for example. Or it can encompass particular types of mentions to provide a better indication of which of the content items found is more interesting, more fashionable or more topical for example.

Ranking of content items can encompass predetermined scoring of content items by searching for online mentions before the search query is known, then comparing scores of found content items, or searching for online mentions only once the relevant content items have been found, then comparing the scores. In either case, scores can be based on numbers of mentions, and the numbers can optionally be weighted according to qualities of the mentions. The qualities of the mentions can encompass for example how far the mentions are spread over different sites or different discussion threads, whether the mentions appear to be positive or negative, how up to date is the mention, whether it is a human moderated discussion and thus less likely to be “gamed”, how highly regarded is the views in the discussion or site, and so on.

The predetermined scoring can encompass prioritizing or biasing of crawling of sites that score highly, or inserting scores in an index of crawled web pages, or in ranking content items other than web pages directly.

### FIG. 1, Embodiment Using Two Corpuses

FIG. 1 shows an overall view of some parts of an embodiment of a search engine using a first corpus for finding content items and a second corpus for finding mentions of the content items for use in ranking. Other parts not illustrated can be added to the parts illustrated. The search engine can include the corpus, or can use external corpuses. The search engine can be implemented as software running on conventional processing hardware of any type, so either the software, or the combination of software and hardware can be regarded as the search engine. A query server 50 of the search engine acts as an interface to users and receives a search query from a user 5. The query server is coupled to send the search query to an arrangement 8 of any type for finding content items relevant to the query. This arrangement is coupled to search over the first corpus 6 of content items. Various ways can be envisaged for implementing this arrangement, and some will be described in more detail below. As shown in FIG. 1, relevant content items found are fed to an arrangement 4 for ranking the content items according to their mentions. Again various ways of implementing this can be envisaged as will be explained. This part is fed by an arrangement 9 for determining a count and optionally qualities of mentions of content items in a second corpus 7. Again, various ways of implementing this can be envisaged. The ranking arrangement 4 feeds ranked content items back to the query server for delivery as search results back to the user 5. These parts can be implemented as software modules run by the query server, or can be distributed to be run by different servers as desired. As mentioned above, the corpuses can be overlapping, or one can be a subset of the other for example.

### FIG. 2, Embodiment Using Plain Text Mentions

This figure shows an overview of another embodiment of the invention. Parts corresponding to those in FIG. 1 have the same reference signs. In this case there is a different arrangement 13 for determining a number/quality of mentions. It involves determining a number and optionally qualities of mentions in plain text referring to the content items. The corpus used for finding the number of such mentions need not be a different corpus. It can use a different corpus from the first corpus, or, as shown, it can use the same first corpus as is used for the search for the content items. As in FIG. 1, relevant content items found are fed to an arrangement 4 for ranking the content items according to their mentions. Again various ways of implementing this can be envisaged as will be explained. This part is fed by an arrangement 9 for determining a count and optionally qualities of mentions of content items in a second corpus 7. Again, various ways of implementing this can be envisaged. The ranking arrangement 4 feeds ranked content items back to the query server for delivery as search results back to the user 5. These parts can be implemented as software modules run by the query server, or can be distributed to be run by different servers as desired. As mentioned above, the corpuses can be overlapping, or one can be a subset of the other for example.

### FIG. 3, Embodiment Using Social Distance

This figure shows an overview of another embodiment of the invention. Parts corresponding to those in FIG. 1 have the same reference signs. As in FIG. 2, the query server 50 receives a search query from user 5. The query server is coupled to send the search query to an arrangement 8 of any type for finding content items relevant to the query. This arrangement finds content items in the first corpus 6 of content items. Relevant content items found are fed to an arrangement for ranking the content items according to their mentions. In this case there is a different ranking arrangement 16 for ranking according to social distance. Again, various ways of implementing this can be envisaged, and other factors not shown can be combined in the ranking, such as prior art ranking methods or those of FIGS. 1 and 2 for example. Feeding this ranking part is an arrangement 14 to determine the social distance of other users. Then the ranking arrangement 16 can determine if any of the relevant content items are owned by other users in the sense of being found in their collections, or having been selected, discussed or reviewed by them, or having been created by them, or found in searches by them for example, or associated with them in any other way. For such content items, the ranking arrangement determines a social distance score for the content item, which can be used for ranking. The ranking arrangement feeds ranked content items back to the query server for delivery as search results back to the user 5. As before, these parts can be implemented as software modules run by the query server, or can be distributed to be run by different servers as desired.

### Social Distance

“social distance” between any two users can encompass any measure of how close is their social relationship, including whether the other user is chosen as a friend, or in their contacts list, has a family relationship, whether they live in the same neighbourhood, same school and so on. The social distance can be measured in terms of a number of hops, in a graph of such social relationships for example. Different types of social relationships can be used and combined to give an aggregate or average score. Social networking websites allow users to register an account, populate their account with content (such as text, html, images, videos, other media files) and declare lists of friends. Their friends' accounts are similarly populated with further content and lists of further friends. Thus in the example of a social network, the immediate friends of user A have a social distance of one, and the friends of the friends of user A (whom are not also direct friends of user A) have a social distance of two, and so on.

Notably this measure of social distance can be used to help in the ranking of search results, where these search results originate from the content contained in (or linked to by) the account of another social-network user.

Embodiments of the invention can include software, systems (meaning software and hardware for running the software) or signals exchanged with a user, to provide a search service for finding online content, arranged to rank search results according to a social distance as defined above. The social distance can be determined earlier by other software, as soon as the user logs into the search service and can be stored ready for use in the ranking step. It can be convenient to store the corresponding social distance for each content item. Accordingly another aspect provides software or systems or signals for providing a social distance service to determine social distance for each content item from social networks, and store the social distances for use in the ranking of search results by such a search service.

Embodiments of the invention can include methods of using a search service to search for online content, by sending a search query to the search service, and receiving corresponding search results of relevant content ranked according to social distance as defined above, at least for content in the search results related to other users of social networks.

In a preferred embodiment, a mobile search engine is implemented consisting of the usual components discussed with reference to other figures.

The back-end crawler can crawl (download and index) content from the web in general, and including from one or more social networking sites. The crawl process may consist of only indexing publicly available data, and/or it may optionally include using previously supplied login credentials of so-called “registered” users to also index data private to those users.

When a user is using the search engine and has been authenticated via login, cookie or other mechanism, the search engine will include results that originate from both the web in general and from one or more social sites. The search results that originate from the social sites may be publicly available content or they may be only available to that (authenticated) user. The social distance of the other users' accounts can assist in the ranking of content from those other users in the search results. The smaller the social distance the higher the ranking content coming from those users accounts will receive in the search results. The larger the social distance, the lower the ranking content coming from those users accounts will receive.

The social distance value could be the sole sorting criteria in ranking candidate search results, or it could be one of many factors combined with various (tunable) weighting. The principle is that a user is likely to be more interested in seeing candidate search results that originate from a friend's content collection than those from a more remote connection or one with no connection at all.

The search engine could be a service available to desktop browsers or mobile handset browsers alike. The social network site that is being indexed for candidate search results could be a desktop accessible website, a mobile-accessible website or both.

The search engine index is not limited to the content originating from just one social network site. The indexed content could originate from multiple social networking sites and be aggregated per user registered with the search engine site. The form of this aggregation is to store, per user, their login credentials per social networking site of which they are a member and to individually crawl the private (or public if publicly available) areas for that user and the areas available only to that user via their friends. An important feature of such a search engine is to only return search results for which the user has permission to view. The search engine service may itself provide a social networking function whereby users can register, publish content (links, text, html, images, videos, and other media) and declare lists of friends. This network can also yield a social distance metric in the ranking of candidate search results when they originate from the account of another registered user.

In the situation where two users, A and B, are both members of two social networking sites, X and Y, but where the social distance of B from A is different on network X compared to network Y, the search engine can optionally use the smaller social distance in the ranking of search results for A that originate from B. Thus if there is content in B's account on a networking site where there is no connection to A, the social distance metric can still be used on such content if there is a connection between A and B on some other networking site. The knowledge of these various memberships is therefore a part of the user management of the search engine. Any of the various features described above can be combined with any other of the features and with other known features. It is particularly useful to combine the features described above with features of mobile searches as described in preceding applications by the present applicants, referenced above.

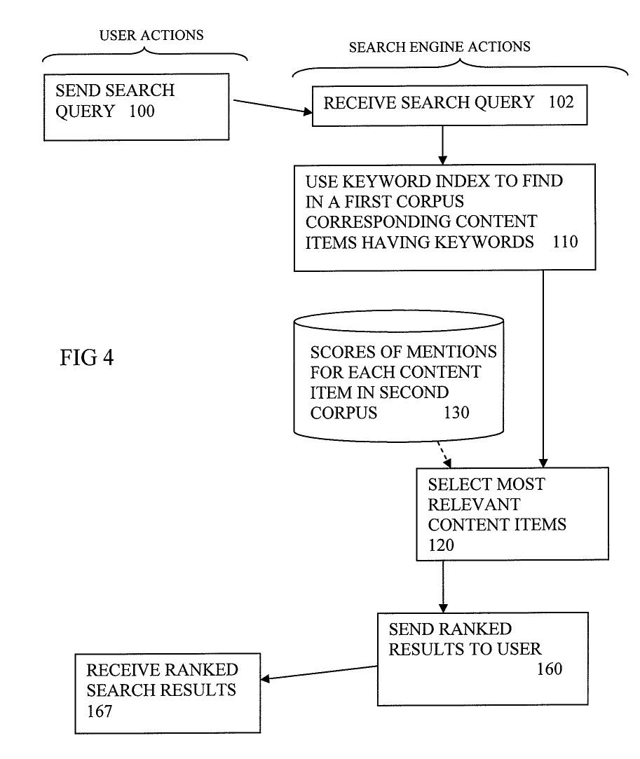

### FIGS. 4 to 6, Actions of Parts of Embodiments Using Mentions for Ranking

FIG. 4 shows a flow chart of actions of some parts. Solid arrows show program flow and dotted lines represent data inputs. A user's actions are shown at the left side, and actions of the search engine are shown at the right side. At step 100, a user sends a search query to a search engine providing a search service. The search engine receives the query at step 102. At step 110 the search engine uses a keyword index to find, in a first corpus, corresponding content items having such keywords. The most relevant content items are selected at step 120, based on inputs including scores from a database 130 of mentions scores. These represent counts of mentions in the second corpus. At step 160 ranked results are sent to the user, and received by the user as shown at step 167.

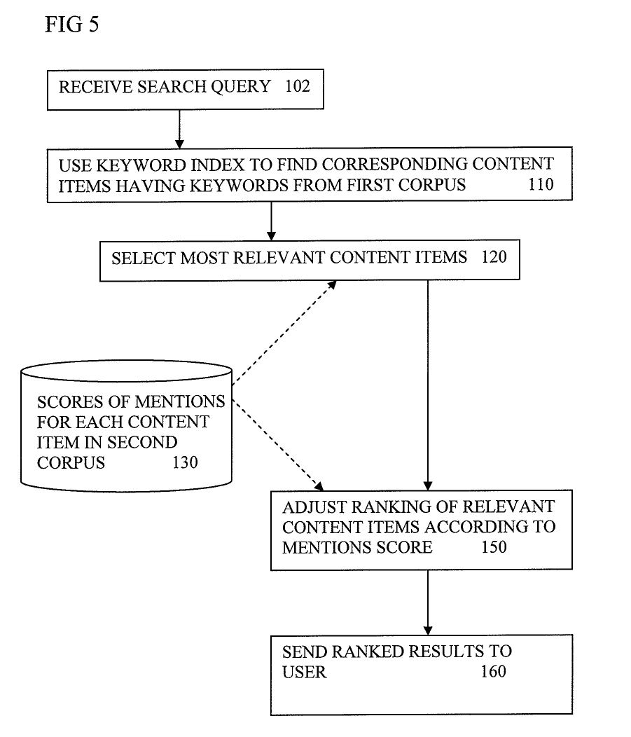

FIG. 5 shows an alternative embodiment similar to that of FIG. 4. In FIG. 5 items 102, 110, 120 and 160 correspond to those same items in FIG. 4. In this case there are separate steps for selecting the most relevant content items and at step 150, adjusting a ranking of relevant content items according to their mentions scores. This can enable the ranking to be done on a limited number of content items, to reduce the computing resources required. Ranking can be regarded as a sorting exercise, and many well known algorithms are available for sorting, which can be used here, using the scores of mentions from database 130, and optionally other factors in combination.

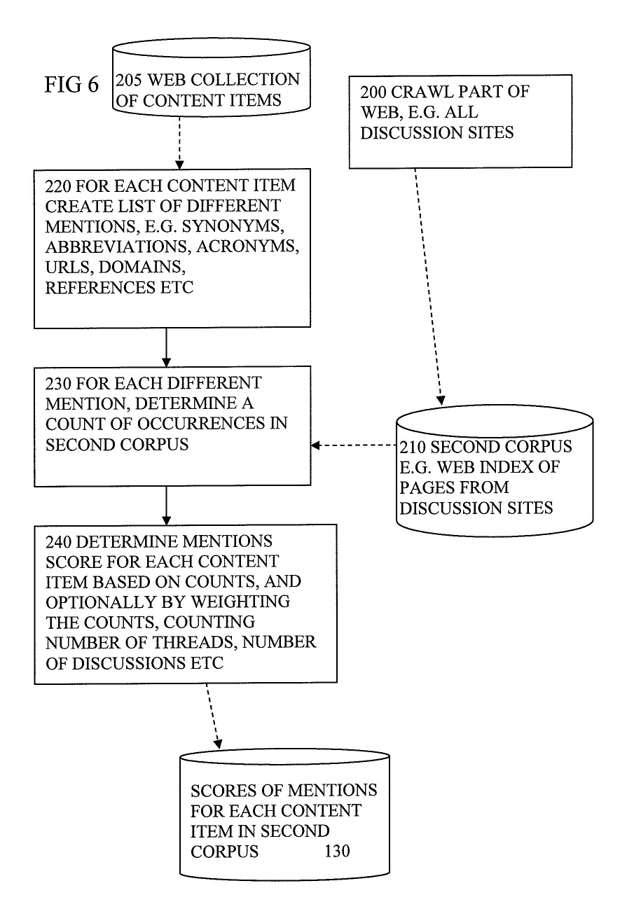

FIG. 6 shows a flow chart of actions involved in building up the database 130 of mentions scores. At step 220, content items in a corpus in the form of a web collection of content items 205 are accessed. For each content item, a list of different mentions is created. This can include a title, a product name, a URL, or any way of referring to the content item including abbreviations, synonyms acronyms and so on. The different mentions can be specific to the media type of the content item, so a music track or video clip might have a title and artist, artist's surname, artist's nickname, artist's homepage URL, blog address and so on. For a content item such as a news item, the mention list might include a headline, a keyword, a URL, a domain name and so on. This list can be generated manually or automatically, depending on the type of content item.

At step 230, for each different mention, a count of occurrences in the second corpus is determined. At step 240, a mentions score is determined for each content item, based on counts, and optionally including weighting the counts. The weighting can involve counting the number of threads, a number of discussions, and weighting according to how specific or generic is the mention in relation to the content item.

### Other Implementation Considerations:

In some embodiments, a mobile search engine is implemented consisting of the usual components of a search engine: front end query server, indexer and indexes, and back-end crawler components that collect URLs to mobile pages. Examples of suitable components are shown in more detail in the above referenced related applications, particularly:

Packaged Mobile Search Results—U.S. application Ser. No. 11/369,025;
Display Search Results on Mobile Device Browser With Background Process—U.S. application Ser. No. 11/289,078;
Processing and Sending Search Results Over Wireless Network to a Mobile Device—U.S. application Ser. No. 11/189,312.

The front end query server can in some embodiments provide a mobile friendly interface (i.e. HTML that can be reasonably viewed and navigated on a mobile handset). The search results can be formatted as a portion of a web page, and the user interface be arranged to constrain a size and text format of the search results so that they can reasonably be viewed on a screen of a hand held mobile device (in other words be suited to or usable on the screen). It is more convenient for mobile users if the page or an area of text is narrowed so that left or right scrolling is minimized. Text font size may be enlarged to maintain readability. Images may be resized or made into thumbnails which can be expanded by clicking for example. A typical screen size is 4×6 cm or 5×7 cm or 6×9 cm approximately, and often with a “portrait” rather than “landscape” orientation. In other cases the mobile friendly search results may be constrained in other ways, to limit usage of bandwidth or processing or memory resources for example.

The back-end crawler identifies as many mobile sites and pages as it can find and accumulate over time. In addition this component also crawls (downloads the contents of) a number of discussion sites. The collection of sites to use can be provided by system operators or through a wider web crawl with heuristics to determine whether or not a site hosts a discussion. Discussion sites include forums, blogs, wikis, and any other human-contributed conversation based content. In the case of wikis, the crawler looks in the comments section of each article in addition to the contents of each article as these comments often play host to lively and topical conversation.

The collected contents of these discussion pages are then analysed for mentions of URLs to mobile sites. In the simplest embodiment of this invention, the total number of mentions of a particular URL is treated as the buzz score, and the buzz score can then be associated with the URL and used by the query server when sorting search results from the index. To achieve this:
The HTML of each discussion site is downloaded,
this HTML is scanned by the software and each match for the characters of the URL cause a counter to be incremented
when the scan is complete, the count is stored in the database record that is holding meta-data (additional data) for the URL and
later, when a search is being performed and a list of candidate URLs has been identified, the score of each URL is looked up in the database and used to sort the list of candidate URLs.

In a more complex embodiment of this invention, the following are recorded separately and separately used as independent factors in the sorting algorithm:
The number of threads of conversation mentioning a URL (discounts an exceptional single lively conversation about a URL where the URL appears many times, but only in one conversation and hence should count less significantly towards the measure of buzz for the URL), and
the number of different discussion sites mentioning a URL (similar to the conversation argument, as it is more significant if a URL is mentioned on several different sites than merely many times within one site).

A benefit of at least some embodiments of this invention is that some or all of the source sites contributing to this buzz score are human edited. If the set of discussion sites is controlled by human operators, then the algorithm gains significant protection against malicious users attempting to game the scoring mechanism. In order to game the buzz score, a malicious user would need to somehow insert multiple mentions of a URL into conversations. However, if these conversations are human moderated, then such attempts will be easily rejected.

In another embodiment of this invention, the sites used to collect mentions of the URL can be any web site whose content is from users whose inputs are human moderated.

In another embodiment of this invention, the degree of strictness in matching a URL in a conversation can be relaxed such that partial matches of the domain, sub-domain, or partial paths are also counted as mentions.

In another embodiment, the mentions are counted per mobile site. This is achieved by only matching domain and/or sub-domain mentions in conversations. While in yet another embodiment, the mentions are counted per individual page within a site. This is achieved by treating the URL as a strict match only.

In another embodiment, the number of mentions of a URL is ascertained using a 3rd party search engine. Here, when a candidate mobile site is being processed by the back-end crawler, a search is performed for that sites URL on a 3rd party search engine. The result page of that search is then scanned for the display of the total number of results for that term. This value can then be used as the buzz score. This technique will work better if the 3rd party search engine is limited to searching human contributed sites (for example, a wiki search engine, or a blog search engine).

In all of the above embodiments, the process of obtaining the number of mentions of a site or page is repeated at a suitable frequency to keep up with the rising and falling popularity of sites. While this can be a tunable parameter in the system, values in the range 1 day to 1 month should prove useful.

Although described in the context of improving mobile search, some embodiments can also be applied to desktop pages and sites. In this case, the preferred embodiment is as above, except that the crawlers are not limited to mobile web sites and the user interface is a normal HTML front end.

Any of the various features described above can be combined with any other of the features and with other known features. It is particularly useful to combine the features described above with features of mobile searches as described in preceding applications by the present applicants, referenced above.

As has been described, some embodiments of this invention provide software or systems or signals exchanged with users to provide a search service for finding online content, arranged to rank search results according to a buzz score as defined above, of the websites having the content. The buzz score can be determined earlier by other software and stored ready for use in the ranking step. The index has the website address for each item of indexed content, so it is convenient to store the corresponding buzz score alongside each address in the index. Accordingly another aspect provides software or systems or signals exchanged with users for providing a buzz scoring service to find online mentions of websites, determine buzz scores for each website, and store the buzz scores for use in the ranking of search results by such a search service.

Another aspect provides a method of using a search service to search for any kind of online content (i.e. not necessarily limited to either mobile web pages nor web pages in general), by sending a search query to the search service, and receiving corresponding search results of relevant online content ranked according to buzz scores as defined above, for websites having the relevant online content.

Further, the buzz score does not need to be limited to counting mentions of the URL of the relevant online content, but could be deduced by counting the occurrences of any string that (preferably uniquely but does not have to be) identifies the content.

An additional feature of some embodiments is: a prevalence ranking server to carry out the ranking of the candidate content items, according to a rate of change of the mentions over time (henceforth called prevalence growth rate), a rate of change of prevalence growth rate (henceforth called prevalence acceleration), or a quality metric of the website associated with the mention. This can help enable more relevant results to be found, or provide richer information about a given mention for example.

An additional feature of some embodiments is a web collections server arranged to determine which websites on the world wide web to revisit and at what frequency, to provide content items or mentions to the search engine. The web collections server can be arranged to determine selections of websites according to any one or more of: media type of the content items, subject category of the content items and the record of content items or mentions associated with the websites. The search results can comprise a list of content items, such as titles and URLs, or richer summaries of them, and an indication of rank of the listed content items in any form. This can help enable the search to return more relevant results.

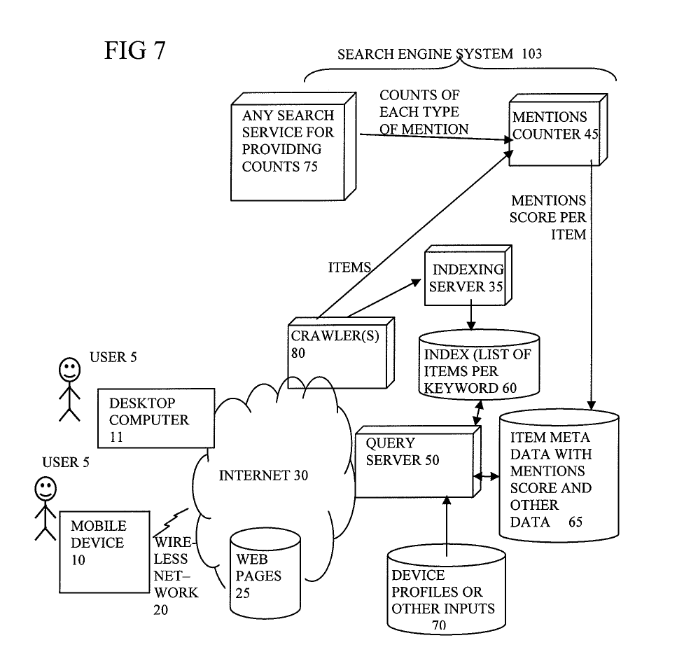

### FIG. 7, Overall Topology

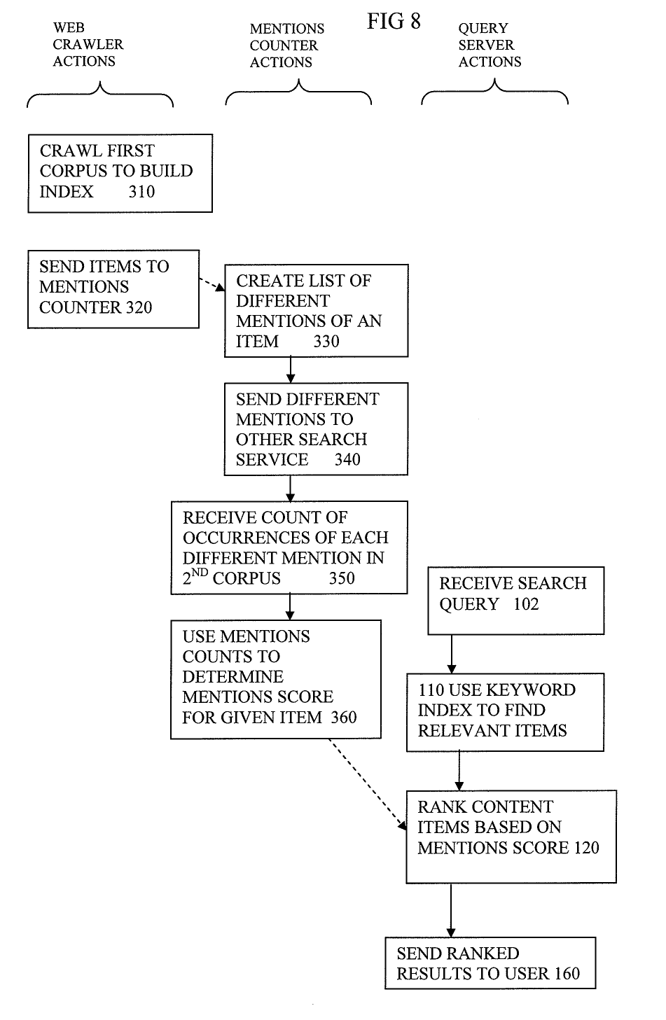

An example of an overall topology of an embodiment of the invention is illustrated in FIG. 7. FIG. 8 shows a summary of some of the main processes. In FIG. 7, a query server 50 and web crawler 80 are connected to the Internet 30 (and implemented as Web servers—for the purposes of this diagram the web servers are integral to the query and web crawler servers). The web crawler spiders the World Wide Web to access web pages 25 and typically builds up a web mirror database (not shown) of locally-cached web pages. The portion of the web reached, or the web mirror, can be regarded as the corpus. The crawler can control which websites are revisited and how often, to keep up to date with changes in the corpuses. An index server 35 builds an index 60 of the web pages from this web mirror. Also shown in FIG. 7 is a mentions counter 45 which can generate a mentions score for each content item for use by the query server in calculating rankings. The mentions scores can be stored in a meta data store 65, along with other data for each content item. The mentions counter builds a mentions score based on counts of different types of mentions. These counts can be provided by any type of search service 75 which may be part of the search engine or external to it. These parts form a search engine system 103. This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device. Such user preferences or device profiles and any other inputs can be stored in a database 70, coupled to the query server.

Many variations are envisaged, for example the content items can be elsewhere than the world wide web, and the mentions counter or index servers could take content from its source rather than the web mirror and so on.

### Description of Devices

The user can access the search engine from any kind of computing device, including desktop, laptop and hand held computers. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or micro browser applications e.g. Openwave™, Access™, Opera™ browsers, which can access web pages across the Internet. These may be normal HTML web pages, or they may be pages formatted specifically for mobile devices using various subsets and variants of HTML, including cHTML, DHTML, XHTML, XHTML Basic and XHTML Mobile Profile. The browsers allow the users to click on hyperlinks within web pages which contain URLs (uniform resource locators) which direct the browser to retrieve a new web page.

### Description of Servers

There are four main types of server that are envisaged in one embodiment of the search engine according to the invention as shown in FIG. 1, as follows. Although illustrated as separate servers, the same functions can be arranged or divided in different ways to run on different numbers of servers or as different numbers of processes, or be run by different organisations. Hence the use of the term server is not intended to limit to a single processor at a single location, a server can represent a function or functions which are distributed over multiple processors at different locations for example, or multiple servers can be implemented on a single processor.
a) A query server 50 that handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results, or this can be carried out by a separate ranking server. In principle the functions of receiving of queries and returning search results need not be carried out at the same place, they can be distributed.
b) A web crawler 80 or crawlers to traverse the World Wide Web, loading web pages as it goes into a web mirror database, which is used for later indexing and analyzing. It controls which websites are revisited and how often, to enable changes in occurrences to be detected. This server can be arranged to maintain web collections which can represent portions of the web in the form of lists of URLs of pages or websites to be crawled. The crawlers are well known devices or software and so need not be described here in more detail
c) An index server 35 that builds a searchable index of all the web pages in the web mirror, stored in the index, this index containing relevancy ranking information to allow users to be sent relevancy-ranked lists of search results. This is usually indexed by ID of the content and by keywords contained in the content.
d) A mentions counter 45 as described above.

Web server programs are integral to the query server and the web crawler servers in some cases. These can be implemented to run Apache™ or some similar program, handling multiple simultaneous HTTP and FTP communication protocol sessions with users connecting over the Internet. The query server is connected to a database 70 that stores detailed device profile information on mobile devices and desktop devices, including information on the device screen size, device capabilities and in particular the capabilities of the browser or micro browser running on that device. The database may also store individual user profile information, so that the service can be personalised to individual user needs. This may or may not include usage history information. The search engine can be a system 103 as shown comprising the web crawler, the index server and the query server. It takes as its input a search query request from a user, and returns as an output a prioritised list of search results. Relevancy rankings for these search results are calculated by the search engine by a number of alternative techniques as will be described in more detail.

The mentions score for each content item can be based primarily on counts of mentions, and optionally can be weighted by mention count growth rate or growth acceleration measures, optionally in conjunction with other methods. Such changes can indicate the content is currently particularly popular, or particularly topical, which can help the search engine improve relevancy or improve efficiency. Certain kinds of content e.g. web pages, can be ranked by existing techniques already known in the art, and multimedia content e.g. images, audio, or mobile specific pages, can be ranked with more weight given to mentions scores for example. The type of ranking can be user selectable. For example users can be offered a choice of searching by conventional citation-based measures e.g. Google's™ PageRank™ or by mentions scores or other measures.

### FIG. 8. Actions

FIG. 8 shows a flow chart of actions of some parts of the embodiment of FIG. 7 or other similar embodiment. Actions of a web crawler are shown in a left hand column. Actions of the mentions counter are shown in a central column, and actions of the query server are shown in a right hand column. At step 310 the crawler crawls the first corpus to build an index. Content items found by the crawler are sent at step 320 to the mentions counter. For each item, the mentions counter creates a list of different mentions of the item at step 330, if the content item is likely to be mentioned in different ways. At step 340 the different mentions are sent to the other search service. A count of occurrences of each different mention in the second corpus is received at step 350. At step 360 the mentions counts for different mentions are used to determine a mentions score for each given item.

Meanwhile a search query is received by the query server at step 102. The keyword index is then used to find relevant items at step 110. The query server then uses the mentions scores for each of the relevant items to rank the content items at step 120. Finally the ranked results are sent to the user at step 160, optionally adapted to user preferences and device characteristics, using database 70. Many variations or additions to these steps can be envisaged.

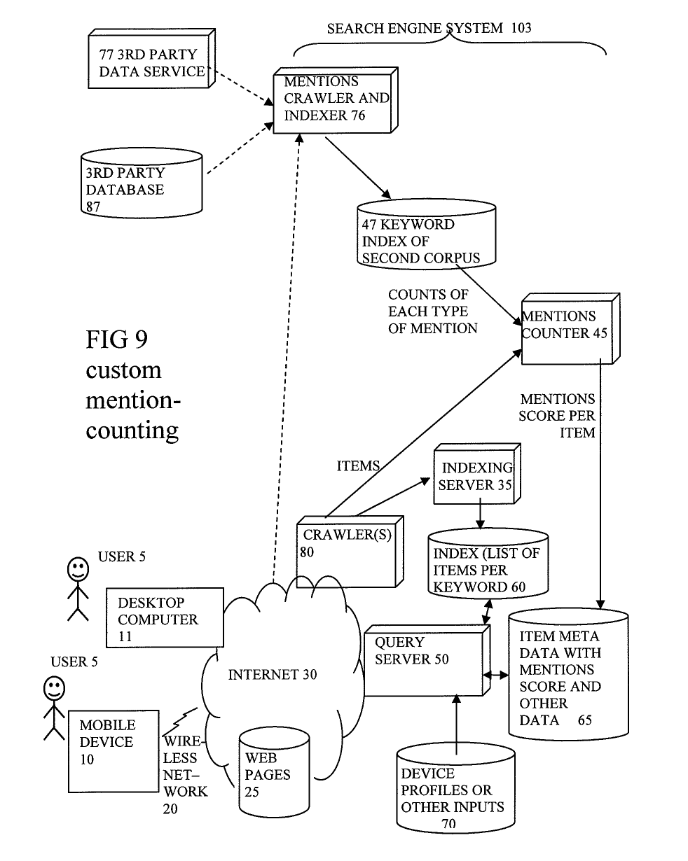

### FIG. 9, Topology for Customised Mention Counting

FIG. 9 shows an overview of another embodiment of the invention, similar to that shown in FIG. 7. Parts corresponding to those in FIG. 7 have the same reference signs. As in FIG. 7 there is a mentions counter 45 which can generate a mentions score for each content item for use by the query server in calculating rankings. In place of the other search service 75 for generating counts, a customised arrangement is shown. A mentions crawler and indexer 76 is provided for crawling and indexing the second corpus, which may involve accessing the internet 30, a 3^{rd} party database 87, or a 3^{rd} party data service 77. The resulting index 47 of the second corpus can be accessed by the mentions counter 45 to find counts of particular types of mentions as before. Having a separate crawler and index means these parts can be tailored for their purposes. The keyword index need not be a full index storing identifiers and locations of each occurrence of a keyword. Also it need not include any ranking information about which items are most relevant for each keyword. Instead it could store a running total of the count for each keyword. If the counts are to be weighted according to their locations, then location information for each occurrence could be stored.

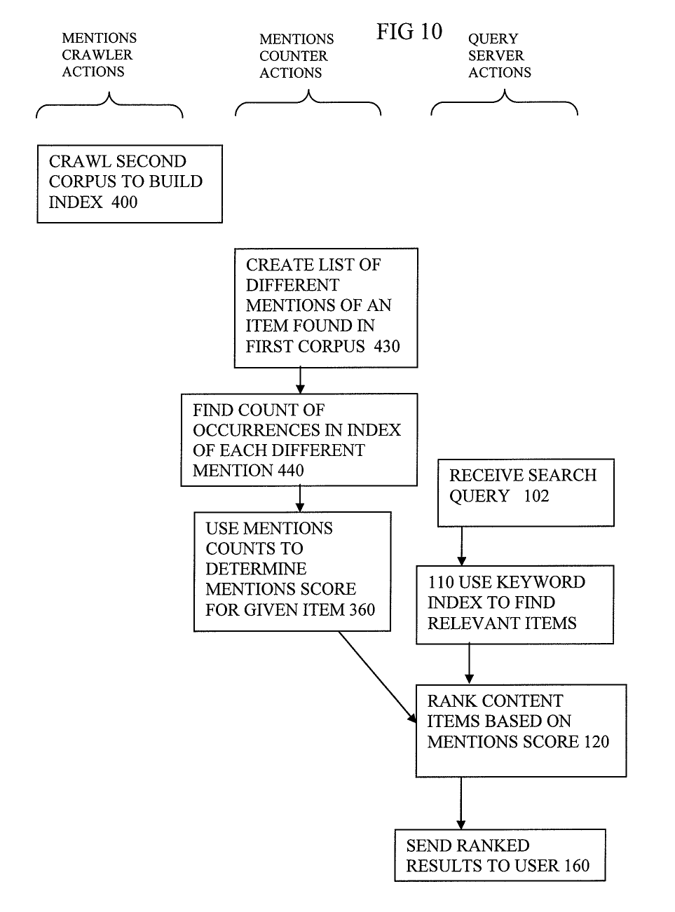

### FIG. 10 Actions for Custom Mention Counting

FIG. 10 shows a corresponding flow chart of actions of some parts of the embodiment of FIG. 9 or other similar embodiment. Actions of the mentions crawler 76 are shown in a left hand column. Actions of the mentions counter are shown in a central column, and actions of the query server are shown in a right hand column. At step 400, the mentions crawler crawls and indexes the second corpus. This index can be a cut down index with no ranking of all the items having a given keyword, as discussed above. The mentions counter receives an indication of items found in the first corpus and for each item creates a list of different mentions of the item at step 430. For each different mention, at step 440 the mentions counter finds a count of occurrences from the index 47 built by the mentions crawler 76. From the various counts, a mentions score is determined at step 360, for a given item. The actions of the query server are as in FIG. 8.

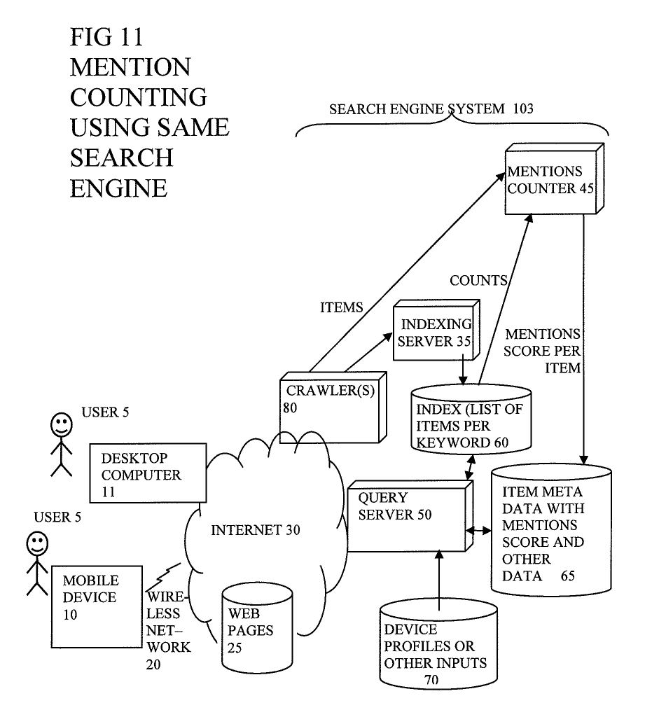

### FIG. 11 Mention Counting Using Same Search Engine

FIG. 11 shows an overview of another embodiment of the invention, similar to that shown in FIG. 7. Parts corresponding to those in FIG. 7 have the same reference signs. As in FIG. 7 there is a mentions counter 45 which can generate a mentions score for each content item for use by the query server in calculating rankings. As before, an indication of items in the first corpus is sent to the mentions counter by the crawler. In place of the other search service 75 for generating counts, the mentions counter uses parts of the search engine already provided for indexing the first corpus. The index 60 provides lists of items per keyword, and can be used by the mentions counter to obtain the count of occurrences of each mention. This can be straightforward if the second corpus is treated as being the same as the first corpus. If the second corpus is different, and is a subset of the first corpus, then the indexing server can be arranged to generate a second index, or to generate a count for each keyword by examining the location of each occurrence to see if it is within the second corpus, and if so increment the count for that keyword. Alternatively, the mentions counter could be used to interrogate the index to achieve this count if desired. Other variations can be envisaged to achieve the counts of each of the mentions.

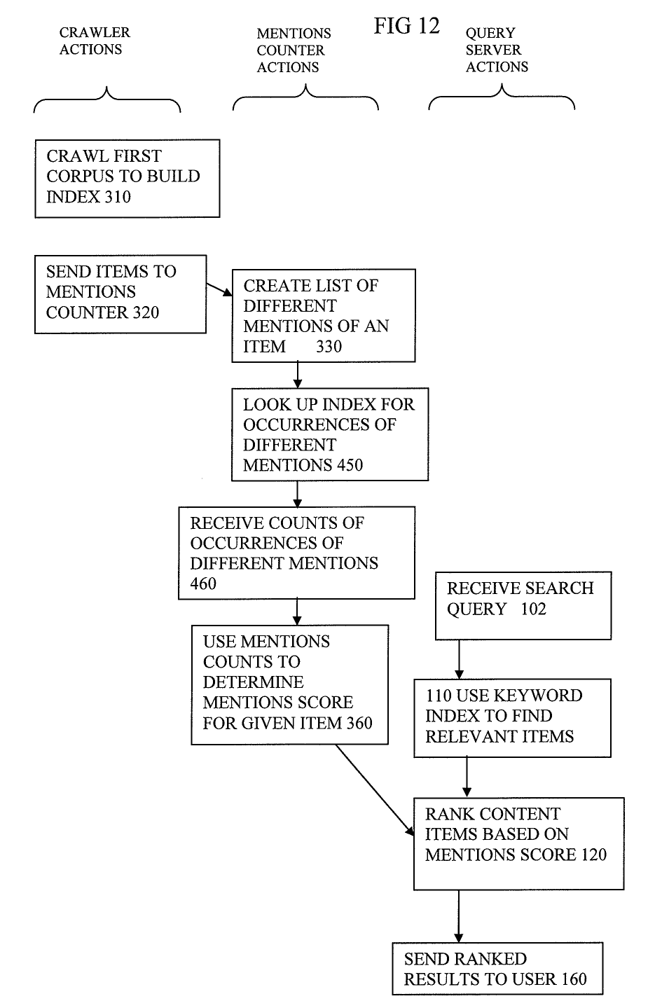

### FIG. 12, Actions for Custom Mention Counting

FIG. 12 shows a corresponding flow chart of actions of some parts of the embodiment of FIG. 11 or other similar embodiment. Actions of the crawler 80 are shown in a left hand column. Actions of the mentions counter are shown in a central column, and actions of the query server are shown in a right hand column. At step 310 the crawler crawls the first corpus to build an index. Content items found by the crawler are sent at step 320 to the mentions counter. For each item, the mentions counter creates a list of different mentions of the item at step 330, if the content item is likely to be mentioned in different ways. At step 450, the mentions counter looks up the index 60 to find a count of occurrences in the second corpus of each different mention. These counts are received at step 460. An alternative is for these counts to be derived by the mentions counter by checking whether the location of each mention is in the second corpus, if the index does not distinguish between first and second corpuses, as described above. At step 360 the mentions counts for different mentions are used to determine a mentions score for each given item. The actions of the query server are as in FIG. 8.

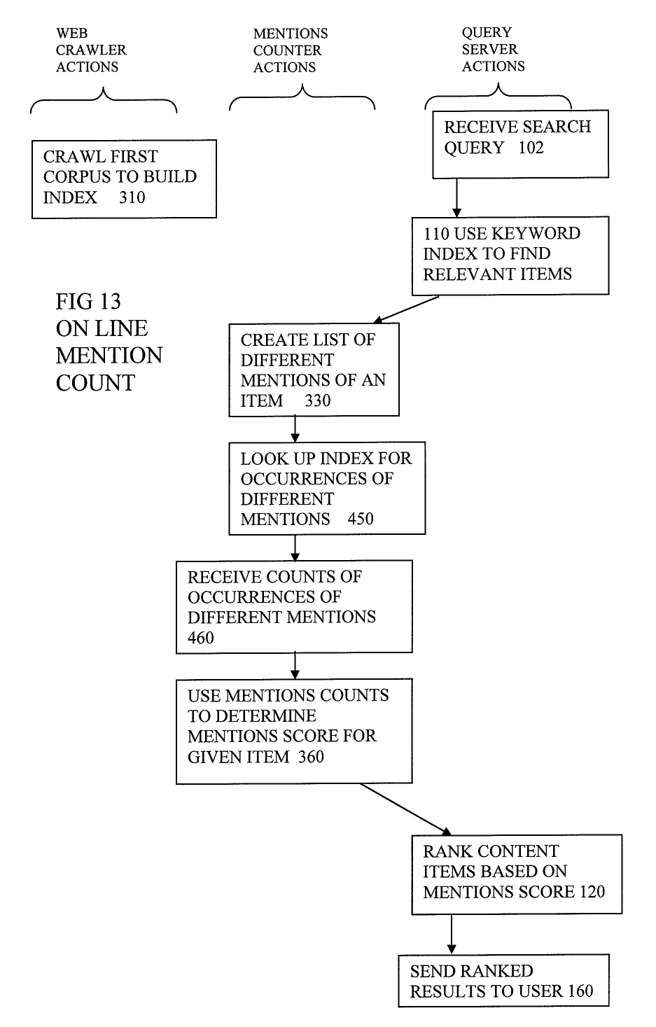

### FIG. 13, Actions for on Line Mention Counting

FIG. 13 shows a flow chart of actions of some parts of an alternative embodiment similar to FIG. 11. In this case the mention count is carried out on line in the sense of being in response to the search query rather than beforehand. Actions of the crawler 80 are shown in a left hand column. Actions of the mentions counter are shown in a central column, and actions of the query server are shown in a right hand column. At step 310 the crawler crawls the first corpus to build an index as before. A search query is received by the query server at step 102. The keyword index is then used to find relevant items at step 110. For each item found, the mentions counter creates a list of different mentions of the item at step 330, if the content item is likely to be mentioned in different ways. At step 450, the mentions counter looks up the index 60 to find a count of occurrences in the second corpus of each different mention. These counts are received at step 460. At step 360 the mentions counts for different mentions are used to determine a mentions score for each given item. The query server then uses the mentions scores for each of the relevant items to rank the content items at step 120. Finally the ranked results are sent to the user at step 160, optionally adapted to user preferences and device characteristics, using database 70.

Obtaining the counts and mention score at the time of the search query may cause delays or need more processing resource, but can reduce storage requirements and can enable the mentions scores to be more up to date. Optionally the mentions scores can be stored as meta data for reuse later to avoid recalculation in future search queries. Many variations or additions to these steps can be envisaged.

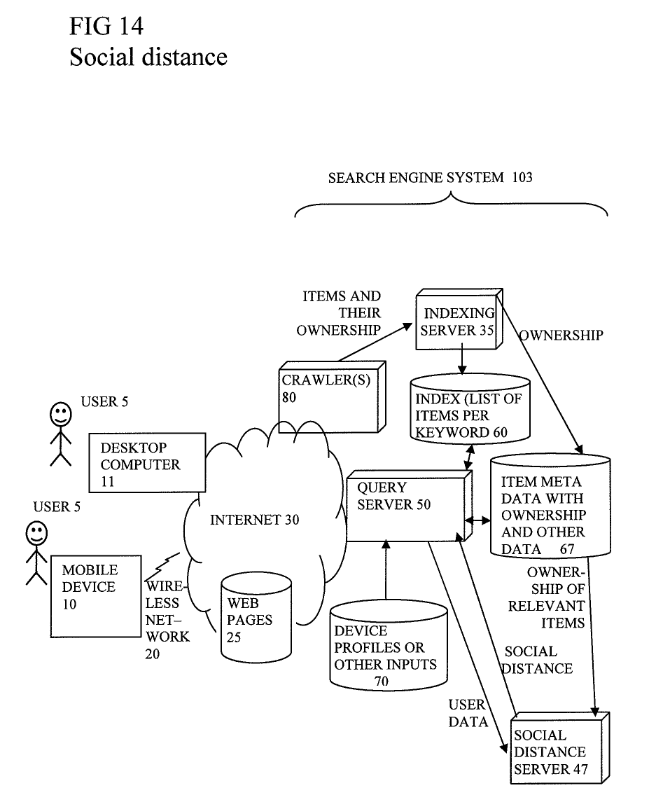

### FIG. 14 Topology Using Social Distance for Ranking

FIG. 14 shows an overview of another embodiment of the invention, similar to that shown in FIG. 7. Parts corresponding to those in FIG. 7 have the same reference signs. A query server 50 and web crawler 80 are connected to the Internet 30. The crawler spiders the World Wide Web to access items such as web pages 25 and is used by the index server 35 to build a keyword index 60 of the content items. In this case ranking is done by social distance (either instead of or in combination with mentions scores as described above). To determine the social distance of each found item, the crawler or indexing server will note the ownership of each content item. Such ownership information can be stored in the meta data database 67 along with other data. A social distance server 47 can be provided for calculating social distance of owners of found content items, relative to the user who sent the query. (This calculation could be carried out by the query server, but is shown here as a separate function for clarity.) The social distance server in this example has links to obtains the indication of found content items from the query server (or the index), and to obtain corresponding ownership information from the meta data database 67. The social distance server has an output to provide a social distance value for each content item to the query server for use in ranking. Other configurations can be envisaged.

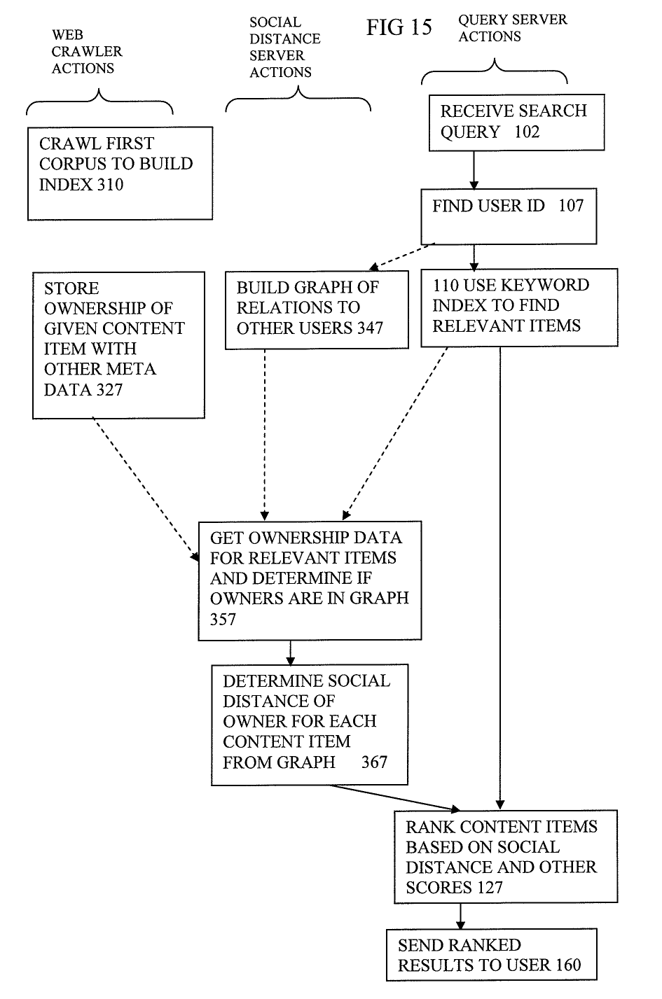

### FIG. 15, Actions for Ranking by Social Distance

FIG. 15 shows a corresponding flow chart of actions of some parts of the embodiment of FIG. 14 or other similar embodiment. Actions of the crawler 80 are shown in a left hand column. Actions of the social distance server 47 are shown in a central column, and actions of the query server 50 are shown in a right hand column. At step 310 the crawler crawls the first corpus to build an index as before. A search query is received by the query server at step 102. At step 107, the query server identifies the user, and the keyword index is then used to find relevant items at step 110. Meanwhile the social distance server (or the query server) builds or looks up a graph of social relations to other users at step 347. This can involve looking up friends in a social network, and looking up friends of friends and so on, if permission is obtained. It can also involve looking up other social relationships such as family members and contacts lists for example. At step 357 the social distance server gets ownership data for relevant items and determines if owners are in the graph of relations to other users. If so, a social distance score is determined for each content item at step 367 based on the number of hops in the graph to the owner. The score may be an aggregate or average score if more than one type of relationship is used, and different inputs to the score may be weighted as appropriate. At step 127, the query server ranks the content items based on social distance scores and other inputs. Finally the ranked results are sent to the user at step 160, optionally adapted to user preferences and device characteristics, using database 70.

Although as shown the social scores are determined on line, it is possible to pre determine ownership and thus social distance for some or all content items for a given user, if the second corpus and the number of users are not too large.

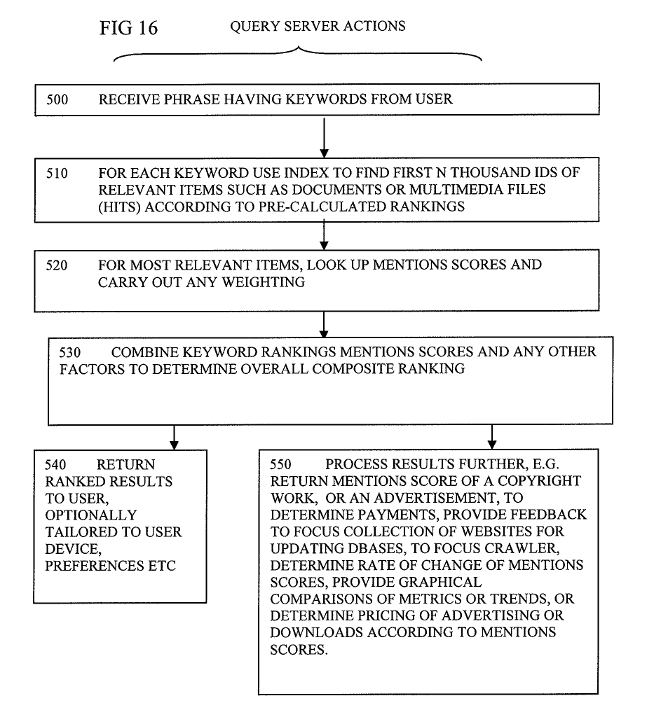

### Query Server FIG. 16

Another embodiment of actions of a query server is shown in FIG. 16. In this example, a phrase having keywords is received from a user at step 500. At step 510, the query server uses an index to find the first n thousand IDs of relevant content items in the form of documents or multimedia files (hits) according to pre-calculated rankings by keyword. At step 520, for the most relevant items, mentions scores are looked up and weighted as appropriate. At step 530, the query server uses keyword rankings, mentions scores and other factors to determine a composite ranking. The query server returns ranked results to the user, optionally tailored to user device, preferences etc at step 540. Alternatively, or as well, at step 550, the query server processes the results further, e.g. returns mentions score as a measure of popularity of a copyright work, or an advertisement, to determine payments, provides feedback to focus web collections of websites for updating dbases, to focus a crawler, provides rates of change of mentions score, provides graphical comparisons of metrics or trends, or determines pricing of advertising or downloads according to mentions scores. Other ways of using the mentions scores can be envisaged.

The query server can be arranged to enable more advanced searches than keyword searches, to narrow the search by dates, by geographical location, by media type and so on. Also, the query server can present the results in graphical form to show mentions scores profiles for one or more content items. Another option can be to present indications of the confidence of the results, such as how frequently relevant websites have been revisited and how long since the mentions score was determined, or other statistical parameters.

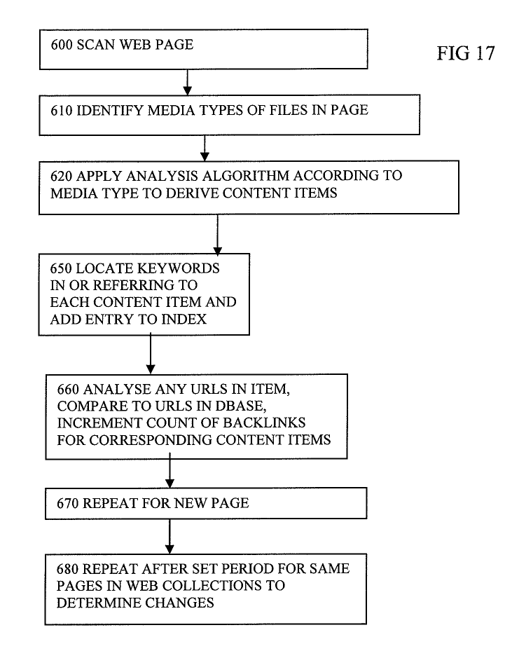

### Index Server FIG. 17

An embodiment of actions of an index server is shown in FIG. 17. In this case, at step 600, a web page is scanned from the web mirror. At step 610 media types of files in the pages are identified. At step 620 an analysis algorithm is applied to each file according to the media type of the file, to derive or extract content items. Optionally the index server can cause the mentions counter to act to obtain a mentions score for each content item, which can be added to the meta data for that content item. At step 650 each content item can be indexed by finding a keyword such as a title or reference for the content item. Accordingly another occurrence of those keywords is added to the index. At step 660, any URLs in the page are analysed and compared to URLs of fingerprints in the fingerprint database or elsewhere. If a match is found, the process increments the count of backlinks for the corresponding fingerprint pointed to by the URL. The same can be done for other types of references such as text references to an author or to a title for example. The process is repeated for a next page at step 670, and after a set period, the pages in a given web collection are rescanned to determine their changes, and keep the index up to date, at least for that web collection. The web collections are selected to be representative.

Embodiments may have any combination of the various features discussed, to suit the application.

Step 1: determine a web collection of web sites to be monitored. This web collection should be large enough to provide a representative sample of sites containing the category of content to be monitored, yet small enough to be revisited on regular and frequent (e.g. daily) basis by a set of web crawlers.
Step 2: set web crawlers running against these sites, and create web mirror containing pages within all these sites.
Step 3: During each time period, scan files in web mirror, for each given web page identify file categories (e.g. audio midi, audio MP3, image JPG, image PNG) which are referenced within this page.
Step 4: For each category, apply the appropriate analyzer algorithm which reads the file, and identifies separate content items from the page.
Step 5: Index the content items.

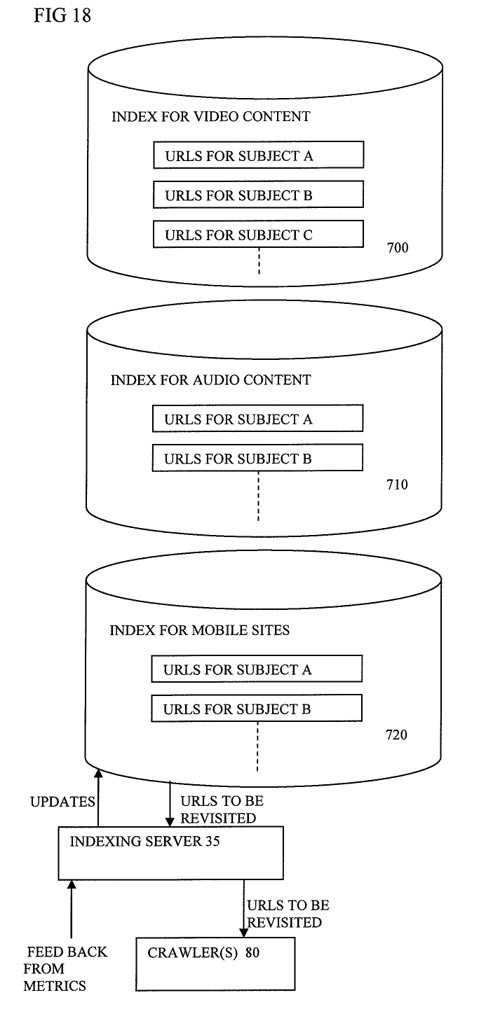

### Web Collections, FIG. 18

FIG. 18 shows an example of indexes for different web collections. Three web collections are shown, there could be many more. A web collection for video content has a keyword index comprising lists of URLs of pages or preferably websites according to subject, in other words different categories of content, for example sport, pop music, shops and so on. A second web collection for audio content, likewise has a keyword index 710 comprising lists of URLs for different subjects. A third web collection for mobile sites again has an index 720 comprising lists of URLs for different subjects. The web collections are for use where there are so many content items that it is impractical to revisit all of them to update the prevalence metrics. Hence the web collections can be a representative selection of popular or active websites which can be revisited more frequently, but large enough to enable changes in prevalence, or at least relative changes in prevalence to be monitored accurately.

The index server 35 can build and maintain the indexes of the web collections to keep them representative, and can control the timing of the revisiting. For different media types or categories of subject, there may be differing requirements for frequency of update, or of size of web collection. The frequency of revisiting can be adapted according to feedback such as which websites change frequently, or which rank highly by mentions score, or backlink rankings. The updates may be made manually. To control the revisiting, the indexing server feeds a stream of URLs to the web crawlers, and can rescan the crawled pages for changes in content items.

### Other Features

In an alternative embodiment, the search is not of the entire web, but of a limited part of the web or a given database.

In another alternative embodiment, the query server also acts as a metasearch engine, commissioning other search engines, whether 3^{rd} party or not, to contribute results and consolidating the results from more than one source.

In an alternative embodiment, the web mirror is used to derive content summaries of the content items. These can be used to form the search results, to provide more useful results than lists of URLs or keywords. This is particularly useful for large content items such as video files. They can be stored along with the fingerprints, but as they have a different purpose to the keywords, in many cases they will not be the same. A content summary can encompass an aspect of a web page (from the world wide web or intranet or other online database of information for example) that can be distilled/extracted/resolved out of that web page as a discrete unit of useful information. It is called a summary because it is a truncated, abbreviated version of the original that is understandable to a user.

Example types of content summary include (but are not restricted to) the following
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, UniX™, OSX™ Windows XP™ and equivalents.

1. A search engine for providing a search service for searching computer accessible content items, the search engine having a query server arranged to receive a search query from a user, find content items relevant to the search query in a first corpus, and return search results to the user indicating at least some of the found content items ranked according to mentions in a second corpus, of the respective found content items.

2. The search engine of claim 1, arranged to rank the search results according to a count of mentions in plain text referring to the respective found content items.

3. The search engine of claim 1, the second corpus comprising the worldwide web.

4. The search engine of claim 3, the second corpus being limited to human moderated discussion sites.

5. The search engine of claim 3, the first corpus being limited to mobile web pages.

6. The search engine of claim 1, arranged to select from a number of indexed web collections for use as the first corpus, each of the indexed web collections being limited to a category of content items.

7. A method of providing a search service for searching computer accessible content items, the method having the steps of receiving a search query from a user, finding content items relevant to the search query in a first corpus, ranking at least some of the found content items according to mentions in a second corpus, of the respective found content items and returning ranked search results to the user.

8. The method of claim 7, the ranking being according to a count of mentions in plain text referring to the respective found content items.

9. The method of claim 7, the second corpus being limited to human moderated discussion sites.

10. The method of claim 7, the first corpus being limited to mobile web pages.

11. A method of using a search service for searching computer accessible content items, the method having the steps of sending a search query from a user to a search service provider, and receiving, from the search service provider, search results in the form of content items relevant to the search query in a first corpus, ranked according to mentions in a second corpus, of the respective found content items.

12. The method of claim 11, the second corpus being limited to human moderated discussion sites.

13. The method of claim 11, involving the user using a mobile device to send the query and receive the search results.

14. The method of any of claims 11, the first corpus being limited to mobile web pages.

15. The method of claim 11, having the step of the user sending to the search service provider an indication of which of a number of indexed web collections to use as the first corpus, each of the indexed web collections being limited to a category of content items.

16. A search engine for providing a search service for searching content items accessible online, the search engine having a query server arranged to receive a search query from a mobile device of a user, and return search results to the user, the search engine being arranged to find content items relevant to the search query, and derive the search results by ranking at least some of the found content items according to at least a count of mentions in plain text referring to the respective found content items.

17. The search engine of claim 16, the ranking being weighted according to whether mentions are in human moderated sites.

18. The search engine of claim 16, the mentions comprising text corresponding to at least a partial match of any of a domain, sub-domain or partial path of a page containing the respective content item.

19. A search engine for providing a search service for searching content items accessible online, the search engine having a query server arranged to receive a search query from a mobile device of a user, find content items relevant to the search query, and return search results to the user, such that at least those of the found content items which are from other users, or related to other users are ranked according to a social distance between the user and the respective other user in a social network.

20. The search engine of claim 19, arranged to crawl a social network site for content items of many other users, to record which other user provided each content item, and record social distance information for each other user.

21. The search engine of claim 20, arranged such that including content items from other users in the search results depends on viewing permissions granted by those other users to the user.

22. A program on a physical medium and executable by computing hardware so as to provide a search service for searching computer accessible content items, the program having a part arranged to receive a search query from a user, and a part for finding content items relevant to the search query in a first corpus, and a part arranged to return search results to the user indicating at least some of the found content items ranked according to mentions in a second corpus, of the respective found content items.
